(19) United States
(12) Patent Application Publication
(10) Pub. No.: US 2008/0163627 A1
(43) Pub. Date: Jul. 10, 2008

(54) FUEL-FLEXIBLE TRIPLE-COUNTER-ROTATING SWIRLER AND METHOD OF USE

(76) Inventors: Ahmed Mostafa ELKady, Clifton Park, NY (US); Andrei Tristan Evulet, Clifton Park, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/621,705

(22) Filed: Jan. 10, 2007

(51) Int. Cl. F02C 7/22

(52) U.S. Cl. 60/737; 60/39.463

(57) ABSTRACT

A flexible fuel fuel-air mixer includes an annular shroud; a center body; an inner swirler disposed around an outer surface of the center body; a low-energy-content fuel plenum having an annul us formed by inner and outer shrouds forming a gap therebetween, a fuel inlet, and a fuel plenum swirler disposed in the gap; an outer swirler having an inner circumferential end portion disposed around the outer shroud of the fuel plenum; and a high-energy-content fuel shroud disposed at the upstream end portion of the annular shroud outwardly from the second swirler in the radial direction and circumferentially around the annular shroud, the fuel shroud being in flow communication with the outer swirler.

### BACKGROUND OF THE INVENTION

1. Field of the Invention

Embodiments of the present invention relate in general to combustors and more particularly, to fuel-flexible, fuel-air mixers of lean-premixed combustors for use in low-emission combustion processes.

2. Description of the Related Art

Historically, the extraction of energy from fuels has been carried out in combustors with diffusion-controlled (also referred to as non-premixed) combustion where the reactants are initially separated and reaction occurs only at the interface between the fuel and oxidizer, where mixing and reaction both take place. Examples of such devices include, but are not limited to, aircraft gas turbine engines and aero-derivative gas turbines for applications in power generation, marine propulsion, gas compression, cogeneration, and offshore platform power to name a few. In designing such combustors, engineers are not only challenged with persistent demands to maintain or reduce the overall size of the combustors, to increase the maximum operating temperature, and to increase specific energy release rates, but also with an ever increasing need to reduce the formation of regulated pollutants and their emission into the environment. Examples of the main pollutants of interest include oxides of nitrogen (NOₓ), carbon monoxide (CO), unburned and partially burned hydrocarbons, and greenhouse gases, such carbon dioxide (CO₂). Because of the difficulty in controlling local composition variations in the flow due to the reliance on fluid mechanical mixing while combustion is taking place, peak temperatures associated with localized stoichiometric burning, residence time in regions with elevated temperatures, and oxygen availability, diffusion-controlled combustors offer a limited capability to meet current and future emission requirements while maintaining the desired levels of increased performance.

Recently, lean-premixed combustors have been used to further reduce the levels of emission of undesirable pollutants. In these combustors, proper amounts of fuel and oxidizer are well mixed in a mixing chamber or region by use of a fuel-air mixer prior to the occurrence of any significant chemical reaction in the combustor, thus facilitating the control of the above-listed difficulties of diffusion-controlled combustors and others known in the art. Conventional fuel-air mixers of premixed burners incorporate a set of inner and outer counter-rotating swirlers disposed generally adjacent an upstream end of a mixing duct for imparting swirl to an air stream. Different ways to inject fuel In such devices are known, including supplying a first fuel to the inner and/or outer annular swirlers, which may include hollow vanes with internal cavities in fluid communication with a fuel manifold in the shroud, and/or injecting a second fuel into the mixing duct by a plurality of orifices in a center body wall in flow communication with a second fuel plenum. In such devices, high-pressure air from a compressor flows into the mixing duct through the swirlers to form an intense shear region and fuel is injected into the mixing duct from the outer swirler vane passages and/or the center body orifices in cross jet flow so that the high-pressure air and the fuel is mixed before a fuel-air mixture is delivered out the downstream end of the mixing duct into the combustor and ignited. Although not being limited to, the fuel of choice for use in lean-premixed combustors is natural gas.

In addition to combustors capable of further reducing the levels of emission of regulated pollutants, lean-premixed combustor technologies with fuel flexibility are of increasing importance. As energy demands and natural gas prices continue to grow in the world, operators of power-producing plants continue to look for alternative fuels, particularly those derived from abundant and inexpensive natural resources, such as coal. Consider, for example, but not as a limitation, the current interest in Integrated gasification combined-cycle technology (IGCC) with advanced combustion systems, in which clean, efficient and cost-effective coal-based power systems have been shown to achieve higher levels of efficiency while simultaneously delivering exhaust gases that meet or exceed current emission levels of regulated pollutants. One of the advantageous features of IGCC units is the combustion of synthesis fuel gases (also known as syngas), which are gases rich in carbon monoxide and hydrogen obtained from gasification processes of coal or other materials. Nevertheless, given the large initial capital cost of existing plants and the need to maintain flexibility, lean-premixed combustors capable of burning natural gas, syngas, or a mixture of both are desirable. However, conventional combustors designed to burn natural gas, or any other high-energy-content fuel, are not capable of burning syngas, or any other low-energy-content fuel, while maintaining the same level of performance and pollutant formation because of the significant changes that are required in geometrical and operational parameters, such as, but not limited to, fuel-air and equivalence ratios for a given flame temperature as well as overall pressure drop, fuel injection velocity, and fuel flow Mach number for a given overall fuel flow effective area.

Therefore, a need exists for a fuel-air mixer for use in lean-premixed combustors having flexibility to burn a high-energy-content fuel and/or a low-energy-content fuel while maintaining or exceeding current levels of performance both in terms of energy output, overall efficiency, operability, and pollutant formation. Such an effort being a positive step in the development of gas turbine combustors aimed at the goal of ultimately converting energy production to a hydrogen-based economy.

### SUMMARY OF THE INVENTION

One or more of the above-summarized needs and others known in the art are addressed by fuel-air mixers that include an annular shroud; a center body; an inner swirler disposed around an outer surface of the center body; a fuel plenum having an annulus formed by inner and outer shrouds extending axially forming a gap therebetween, at least one fuel inlet, and a fuel plenum swirler disposed in the gap formed between the inner and outer shrouds at a downstream portion of the fuel plenum, the inner shroud being disposed circumferentially around the inner swirler; an outer swirler disposed around the outer shroud of the fuel plenum, the inner and outer swirlers being configured to allow independent rotation of respective first and second portions of a first oxidizer stream entering the annular shroud; and a fuel shroud disposed outwardly from the second swirler in a radial direction and circumferentially around the annular shroud, the fuel shroud being in flow communication with the outer swirler.

In another aspect of the disclosed invention, gas turbines are disclosed that include a compressor, a combustor to burn a premixed mixture of fuel and air in flow communication with the compressor, and a turbine located downstream of the combustor to expand high-temperature gas stream exiting the combustor. The combustors of such gas turbines have fuel-air mixers that include an annular shroud; a center body; an inner swirler disposed around an outer surface of the center body; a fuel plenum having an annulus formed by inner and outer shrouds extending axially forming a gap therebetween, at least one fuel inlet, and a fuel plenum swirler disposed in the gap formed between the inner and outer shrouds at a downstream portion of the fuel plenum, the inner shroud being disposed circumferentially around the inner swirler; an outer swirler disposed around the outer shroud of the fuel plenum, the inner and outer swirlers being configured to allow independent rotation of respective first and second portions of a first oxidizer stream entering the annular shroud; and a fuel shroud disposed outwardly from the second swirler in a radial direction and circumferentially around the annular shroud, the fuel shroud being in flow communication with the outer swirler.

In another aspect of the disclosed invention, gas-to-liquid systems are disclosed that include an air separation unit configured to separate oxygen from air, a gas processing unit for preparing natural gas, a combustor for reacting oxygen with the natural gas at an elevated temperature and pressure to produce a synthesis gas enriched with carbon monoxide and hydrogen gas, and a turbo-expander in flow communication with the combustor for extracting work from and for quenching the synthesis gas. The combustor of such gas-to-liquid systems including fuel-air mixers that have an annular shroud; a center body; an inner swirler disposed around an outer surface of the center body; a fuel plenum having an annulus formed by inner and outer shrouds extending axially forming a gap therebetween, at least one fuel inlet, and a fuel plenum swirler disposed in the gap formed between the inner and outer shrouds at a downstream portion of the fuel plenum, the inner shroud being disposed circumferentially around the inner swirler; an outer swirler disposed around the outer shroud of the fuel plenum, the inner and outer swirlers being configured to allow independent rotation of respective first and second portions of a first oxidizer stream entering the annular shroud; and a fuel shroud disposed outwardly from the second swirler in a radial direction and circumferentially around the annular shroud, the fuel shroud being in flow communication with the outer swirler.

Methods for premixing a high-energy-content fuel or a low-energy-content fuel and an oxidizer in a combustion system are also within the scope of the embodiments of the invention disclosed, such methods including the steps of drawing a first stream of oxidizer inside an annular shroud of a fuel-air mixer; swirling a first portion of the first stream of oxidizer in an outer swirler in a first direction; swirling a second portion of the first stream of oxidizer in an inner swirler in a second direction; and injecting the high-energy-content fuel into the fuel-air mixer from a fuel shroud in flow communication with fuel inlet orifices in the outer swirler or injecting the low-energy-content fuel into the fuel-air mixer from a fuel plenum, the fuel plenum including an annulus formed by inner and outer shrouds extending axially forming a gap therebetween, at least one fuel inlet disposed at an upstream portion of the fuel plenum, and a fuel plenum swirler disposed in the gap formed between the inner and outer shrouds at a downstream portion of the fuel plenum, the inner shroud of the fuel plenum being disposed circumferentially around an outer circumferential end portion of the inner swirler.

The above brief description sets forth features of the present invention in order that the detailed description thereof that follows may be better understood, and in order that the present contributions to the art may be better appreciated. There are, of course, other features of the invention that will be described hereinafter and which will be for the subject matter of the appended claims.

In this respect, before explaining several preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a diagram of a gas turbine having a combustor with a fuel-air mixer in accordance with aspects of the present technique;

FIG. 2 illustrates an exemplary configuration of a can combustor employed in the gas turbine of FIG. 1 in accordance with aspects of the present technique;

FIG. 3 illustrates another exemplary configuration of a annular combustor employed in the gas turbine of FIG. 1 in accordance with aspects of the present technique;

FIG. 4 illustrates a partial perspective view of another exemplary low-emission annular combustor having a fuel-air mixer in accordance with aspects of the present technique;

FIG. 5 illustrates a perspective view of the fuel-air mixer of FIG. 4;

FIG, 6 illustrates a top view of the fuel-air mixer of FIG. 4 for an observer positioned downstream looking upstream;

FIG. 7 illustrates a bottom view of the fuel-air mixer of FIG. 4 for an observer positioned upstream looking downstream;

FIG. 8 illustrates a partial perspective view of another fuel-air mixer in accordance with aspects of the present technique;

FIG. 9 illustrates a partial perspective view of yet another fuel-air mixer in accordance with aspects of the present technique;

FIG. 10 illustrates a perspective view of the radial swirler of the fuel-air mixer of FIG. 9.

### DETAILED DESCRIPTION OF THE PREFERRED EMBODIMENTS

Referring now to the drawings, wherein like reference numerals designate identical or corresponding parts throughout the different views, several embodiments of the fuel-air mixer devices being disclosed will be described. In the explanations that follow, exemplary embodiments of the disclosed fuel-air mixers used in a gas turbine will be used. Nevertheless, it will be readily apparent to those having ordinary skill in the applicable arts that the same fuel-air mixers may be used in other applications in which combustion is primarily controlled by premixing of a fuel and an oxidizer.

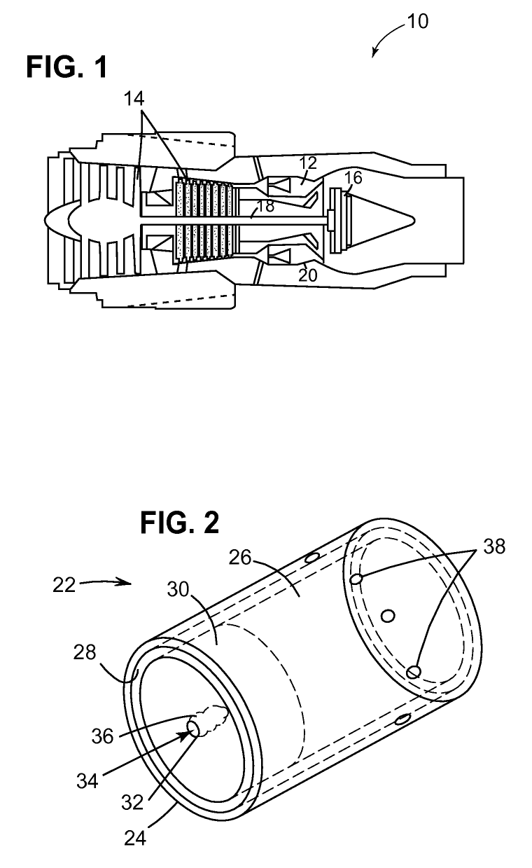

FIG. 1 illustrates a gas turbine 10 having a compressor 14, which, in operation, supplies high-pressure air to a low-emission combustor 12. Subsequent to combustion of fuel injected into the combustor 12 with air (or another oxidizer), high-temperature combustion gases at high pressure exit the combustor 12 and expands through a turbine 16, which drives the compressor 14 via a shaft 18. As understood by those of ordinary skill in the art, references herein to air or airflow also refer to any other oxidizer, including, but not limited to, pure oxygen or a vitiated airflow having a volumetric oxygen content of less than 21% (e.g., 10%). In one embodiment, the combustor 12 includes a can combustor. In an alternate embodiment, the combustor 12 includes a can-annular combustor or a purely annular combustor. Depending on the application, the combustion gases may be further expanded in a nozzle (not shown) in order to generate thrust or gas turbine 10 may have an additional turbine (not shown) to extract additional energy from the combustion gases to drive an external load. As illustrated in FIG 1, the combustor 12 includes a combustor housing 20 defining a combustion area. In addition, as further explained below and illustrated in FIGS. 2-5, the combustor 12 includes a fuel-air mixer for mixing compressed air and fuel prior to combustion in the combustion area.

FIG. 2 illustrated an exemplary configuration of a low-emission combustor 22 employed in the gas turbine 10 of FIG. 1. In the illustrated embodiment, the combustor 22 includes a can combustor with a single fuel-air mixer; however, those of ordinary skill in the art will appreciate that a plurality of mixers may also be used in a given combustor can, depending on the application and desired output. The combustor 22 includes a combustor casing 24 and a combustor liner 26 disposed within the combustor casing 24. The combustor 22 also includes a dome plate 28 and a heat shield 30 configured to reduce the temperature of the combustor walls Further, the combustor 22 includes a fuel-air mixer 32 for premixing the oxidizer and fuel prior to combustion. In one embodiment, the fuel-air mixers 32 may be arranged to achieve staged fuel introduction within the combustor 22 for applications employing fuels such as hydrogen. In operation, the fuel-air mixer 32 receives an airflow 34, which is mixed with the fuel introduced into the fuel-air mixer 32 from a fuel plenum. Subsequently, the air-fuel mixture is burned in flame 36 inside the combustor 22. Dilution or cooling holes 38 may also be provided in the casing 24, as illustrated.

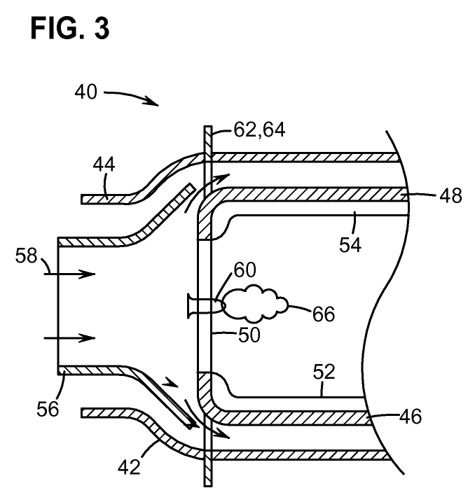

FIG. 3 illustrates another exemplary configuration of a low-emission combustor 40 employed in the gas turbine 10 of FIG. 1. In the illustrated embodiment, the combustor 40 includes an annular combustor with a single fuel-air mixer; however, those of ordinary skill in the art will appreciate that a plurality of circumferentially disposed mixers may also be used in a given annular combustor, depending on the application and desired output. As illustrated, an inner casing 42 and an outer casing 44 define the combustion area within the combustor 40. In addition, the combustor 40 typically includes inner and outer combustor liners 46 and 48 and a dome 50. Further, the combustor 40 includes inner and outer heat shields 52 and 54 disposed adjacent to the inner and outer combustor liners 46 and 48 and a diffuser section 56 for directing an airflow 58 into the combustion area. The combustor 40 also includes a fuel-air mixer 60 disposed upstream of the combustion area. In operation, the fuel-air mixer 60 receives fuel from a fuel plenum via fuel lines 62 and 64. Further, the fuel from the fuel lines 62 and 64 is mixed with the incoming airflow 58 and a fuel-air mixture for combustion is delivered to flame 66.

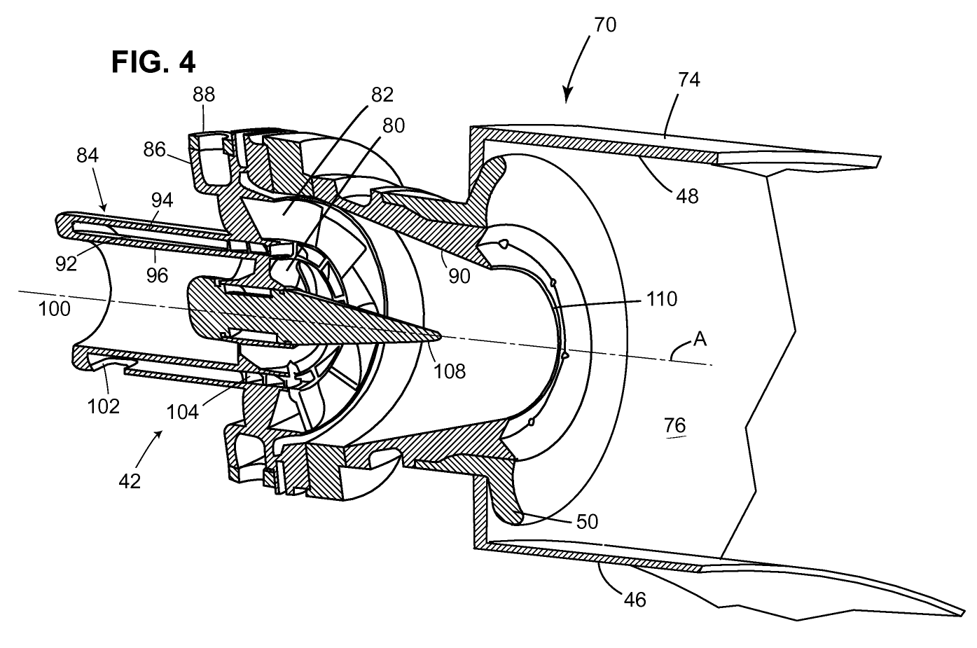

FIG. 4 depicts a partial cross sectional view of another exemplary low-emission annular combustor 70 having a fuel-air mixer 72 in accordance with aspects of the present technique. As those of ordinary skill will understand, the annular combustor 70 is a continuous burning combustion apparatus of the type suitable for use in the gas turbine engine 10 and includes a hollow body 74 that defines a combustion chamber 76 therein. Hollow body 74 is generally annular in form and includes the outer liner 48, the inner liner 46, and the domed end or dome 50. As shown, the domed end 50 of hollow body 74 is connected to the fuel-air mixer 72 to allow for the subsequent introduction of the fuel-air mixture, from the fuel-air mixer 72 into combustion chamber 76 with the minimal formation of pollutants caused by the ignition and combustion of the resulting mixture. Other than the modifications described herein, the fuel-air mixer 72 will generally take the form of the mixers in U.S. Pat. Nos. 5,351,477, 5,251,447 and 5,165,241, which are commonly assigned to the assignee of the present invention and the contents of which are hereby incorporated by reference in their entirety.

As illustrated, the fuel-air mixer 72 includes an inner swirler 80 and an outer swirler 82. The inner and outer swirlers 80 and 82 preferably are counter-rotating. As understood by those of ordinary skill in the art, it matters not in which direction the inner swirler 80 or the outer swirler 82 rotates the air flowing therethrough, as long as the direction of rotation of one swirler is opposite to that of the other. The inner and outer swirlers 80 and 82 are preferably axial, but they may be radial or some combination of axial and radial. As known by those of ordinary skill in the applicable arts, the inner and outer swirlers 80 and 82 have vanes that are disposed at an angle varying from about 40° to about 60° with an axial axis A of the combustor. In addition, a ratio of the mass of air flowing through the inner swirler 80 to that flowing through the outer swirler 82 may be adjusted by design, being preferably approximately equal to one third.

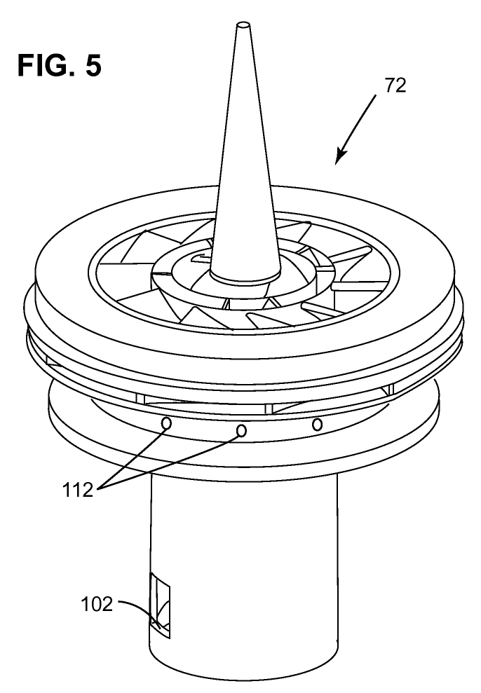

The fuel-air mixer 72 further includes a fuel shroud 86 with a fuel inlet 88, the fuel shroud 86 circumferentially surrounding the mixer at an upstream end thereof, and an annular shroud 90 disposed downstream of the fuel shroud 86. The fuel shroud 86 may be in flow communication with the vanes of the outer swirler 82 and fuel injected therefrom may be metered by an appropriate fuel supply and control mechanism as conventionally known. As such, the vanes of the outer swirler 82 are preferably of a hollow design having internal cavities connected to the fuel shroud 86 and fuel passages to inject the fuel from the fuel shroud 86 into the annular shroud 90 through fuel inlet ports 112 (shown in FIG. 5). As it is also known conventionally, although not depicted in the figures, fuel passages could be provided in the fuel shroud 86 in flow communication with the vanes of the inner swirler 80. According to the techniques of the present invention, the fuel shroud 86 is configured to inject a high-energy-content fuel into the fuel-air mixer 72. A high-energy-content fuel as disclosed herein is a fuel having a low heating value between 30 and 120 MJ/kg. Examples of such fuels include, but are not limited to, natural gas and hydrogen.

As further illustrated in FIG. 4, a low-energy-content fuel plenum 84 separates the inner and outer swirlers 80 and 82 from each other, allowing the inner and outer swirlers 80 and 82 to be co-annular and to separately rotate air entering them. The low-energy-con tent fuel plenum 84 includes two concentric tubular pieces 94 and 96 forming an annulus region with a gap 98 therebetween. At the upstream end 100 of the fuel plenum 84 a fuel inlet 102 is provided. Fuel introduced into the fuel plenum 84 is finally injected into the fuel-air mixer 72 via a third swirler 104 disposed at the downstream end 106 of the fuel plenum 84. The third swirler 104 being substantially coplanar with the inner and outer swirlers 80 and 82, as illustrated. The fuel-air mixer 72 further includes a center body 108 provided in the form of a straight cylindrical section or preferably one that converges substantially uniformly from its upstream end to its downstream end. The center body 108 is preferably sized so as to terminate prior to a downstream end 110 of annular shroud 90.

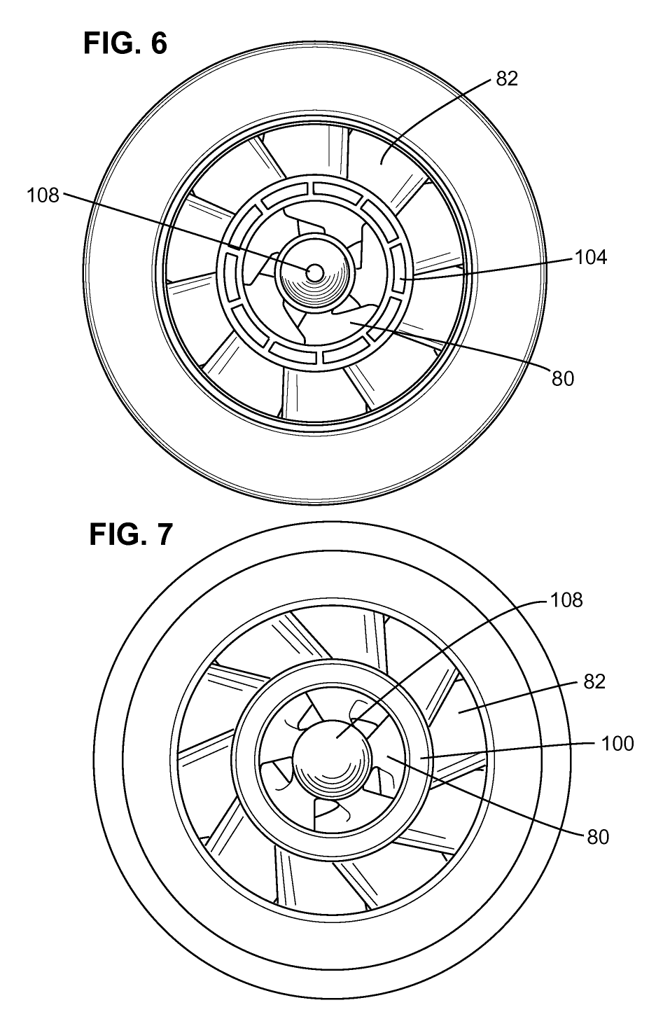

FIGS. 5-7 are further illustrations of the fuel-air mixer 72 of FIG. 4. FIG. 5 is a perspective view, better illustrating fuel-injection orifices 112 for the introduction of the high-energy-content fuel into the fuel-air mixer 72. FIG. 5 also shows one embodiment of the fuel inlet 102 for the introduction of the low-energy-content fuel into the fuel plenum 84. In order embodiments, the fuel plenum 84 may include a plurality of fuel inlets 102 disposed circumferentially around the fuel plenum 84 so as to promote a more uniform fuel injection process into the fuel-air mixer 72 or a separate conical fuel plenum for the low-energy-fuel may be provided. A low-energy-content fuel as disclosed herein is a fuel having a low heating value that is less than 30 MJ/kg. Examples of such fuels include, but are not limited to, 60/40 or 50/50 mixtures of H₂ and N₂, and syngas. FIGS. 6 and 7 are top (for an observer positioned downstream and looking upstream) and bottom (for an observer positioned upstream and looking downstream) views, respectively, of the fuel-air mixer 72 of FIG. 4, illustrating the relative position of the outer swirler 82, the third swirler 104 (FIG. 6), the inner swirler 80, the upstream end 100 of fuel plenum 84 (FIG. 7), and the center body 108.

The effective areas of the inlet ports for the high-energy-content fuel injected from the fuel shroud 86 through the vanes of the inner and/or outer swirlers 80 and 82 and the effective outlet area of the third swirler 104 for the injection of low-energy-content fuel from the fuel plenum 84 are selected so as to permit operation of the fuel-air mixer in a way so as to minimize the overall pressure drop associated with the fuel injection process, fuel injection velocity, and fuel flow Mach number for given design limits of fuel-air and equivalence ratios for a given flame temperature, thereby permitting the operation of the fuel-air mixer 72 with a low-energy-content fuel, a high-energy-content fuel, and/or a combination of both. In addition, those of ordinary skill in the art will appreciate that the ability of both inner and outer swirlers 80 and 82 and the third swirler 104 to properly mix the high- and/or low-energy-content fuels will minimize and/or eliminate flashback or flame holding within the fuel-air mixer 72 or annular shroud 90.

An example on the variation of fuel-air mixer parameters for five different types of fuels is shown below in Table I, which tabulates equivalence ratio, fuel mass flow rate, effective area, percent increase in effective area, and fuel injection velocity and Mach number for a given fuel pressure drop and flame temperature of 2500° F. (1371° C.) for five different fuels. In the results tabulated in Table I, the percent increase in effective area is defined with respect to the effective area for natural gas, i.e., for example, since the effective areas for natural gas and pure hydrogen are 0.015 and 0.018 in², respectively, the percent increase in effective area for natural gas is zero and that for hydrogen is 17.8 (i.e., 17.8=[((0.018−0.015)/0.015)*100]). As understood by those of ordinary skill in the applicable arts, the percent increase in effective area may vary from the values indicated in Table I in view of the likelihood that other gases, besides N₂, may be present in the fuel, such as, but not limited to, CO₂, water as steam, CO, to name a few.

As shown in Table I, if the low-energy-content fuel is a 60/40 or 50/50 mixture of H₂ and N₂, the effective area of the fuel plenum 84 should be approximately 4.67 and 7.13 times larger than the effective area of inlet ports of the fuel shroud 86 for the injection of the high-energy-content fuel, respectively, for a flame temperature of 2500° F. (4371° C.). For syngas, the effective area of fuel plenum 84 should be about 12 times larger than the effective area of inlet ports of the fuel shroud 86. For pure H₂, the effective area of the inlet ports of the fuel shroud 86 is approximately 1.78 times larger than the same area when natural gas is used as the high-energy-content fuel. For fuels containing H₂, including pure hydrogen, the mass flow rate of hydrogen varies only between 0.012 and 0.015 lbm/sec, indicating that, for the different fuels considered, (1) the hydrogen mass flow rate is of the same order of magnitude; (2) if hydrogen is injected alone, the pressure drop across the fuel injection holes will be in the same range for all fuels; and (3) hydrogen and other mixtures (N₂ or N₂/CO) may be injected separately and later mixed with air within the fuel-air mixer for fuel flexibility with acceptable pressure losses.

For a flame temperature ranging from 2000° F. to 3000° F. (or from 1093° C. to 1649° C.), the range in the effective area of the fuel plenum 84 for the 60/40 or the 50/50 mixture of H₂ and N₂ low-energy-con tent fuel is approximately 4.2 to 5.6 and 6.43 to 8.57 times larger than the effective area of inlet ports of the fuel shroud 86 for the injection of natural gas as the high-energy-content fuel, respectively. For syngas and the same range in flame temperature, the effective area of fuel plenum 84 should range from approximately 10.82 to 14.43 times larger than the effective area of inlet ports of the fuel shroud 86. For pure H₂, the range in effective area of the inlet ports of the fuel shroud 86 is approximately from 1.6 to about 2.14 times larger than the same area when natural gas is used as the high-energy-content fuel for flame temperatures in the specified range.

The difficulties in operating with syngas are related to the high volumetric flow required for the same firing rate as compared to natural gas. In these situations, fuel flow area needs to be enlarged by 10-15 times based on the syngas composition. In addition the Wobbe index for syngas is substantially lower than that of natural gas. In use, the fuel-air mixer 72, through the use of the inner and outer counter rotating air swirlers 80 and 82, shears the low-energy-content fuel introduced via the helical swirler 104, such as syngas, assuring proper mixing with air flowing through the inner and outer swirlers before delivering in a swirled motion the fuel-air mixture to the combustion chamber plenum.

TABLE I
List of operating and geometrical parameters of the fuel-air mixer 72 for a given
pressure drop for fuel injection and a flame temperature of 2500° F. (1371° C.).

| | | | | | | A_{effective} for | | U_{fuel} for | Mach # for |
|---|---|---|---|---|---|---|---|---|---|
| | | Percent by | Percent | φ @ | m_{dot}_fuel | const. | % increase | const. | const. |
| Fuel | Composition | volume | by mass | T_flame | (lb/sec) | ΔP_{fuel} (in²) | in A_{effective} | ΔPfuel (ft/s) | ΔPfuel |
| Natural Gas | NatGas | 100 | 100 | 0.477 | 0.029 | 0.015 | — | 653.259 | 0.4633605 |
| Pure Hydrogen | H2 | 100 | 100 | 0.406 | 0.012 | 0.018 | 17.787 | 1885.838 | 0.4485317 |
| 60/40 H2/N2 | H2 | 60 | 9.677 | 0.473 | 0.141 | 0.085 | 466.559 | 759.915 | 0.4487939 |
| Mixture | N2 | 40 | 90.323 | | | | | | |
| 50/50 H2/N2 | H2 | 50 | 6.667 | 0.514 | 0.223 | 0.122 | 713.976 | 691.001 | 0.4488692 |
| Mixture | N2 | 60 | 93.333 | | | | | | |
| Syn Gas | CO | 10 | 13.861 | 0.568 | 0.415 | 0.195 | 1202.525 | 595.542 | 0.4489847 |
| | H2 | 30 | 2.970 | | | | | | |
| | N2 | 60 | 83.168 | | | | | | |

Although not illustrated, those of ordinary skill in the art will appreciate that, in other embodiments, the wall forming the annular shroud 90 may include one or more air passages in flow communication with compressed air from outside the annular shroud 90 so as to permit air to flow inside the annular shroud 90 in order to energize a boundary layer of air and fuel located along an inner surface of the annular shroud 90. These airflow passages may be implemented regardless of the manner in which fuel is injected into the fuel-air mixer 72 or how the fuel and air is mixed therein. This is because the air supplied by such air passages will be effective for energizing the boundary layer along the inner annular surface of the annular shroud 90 and increase the forward velocity of air in the annular shroud 90. Moreover, the air will also have the effect of diluting the concentration of any fuel in the boundary layer and therefore the flame velocity therein, all of which contributing to the decrease of the possibility of flashback within the annular shroud 90.

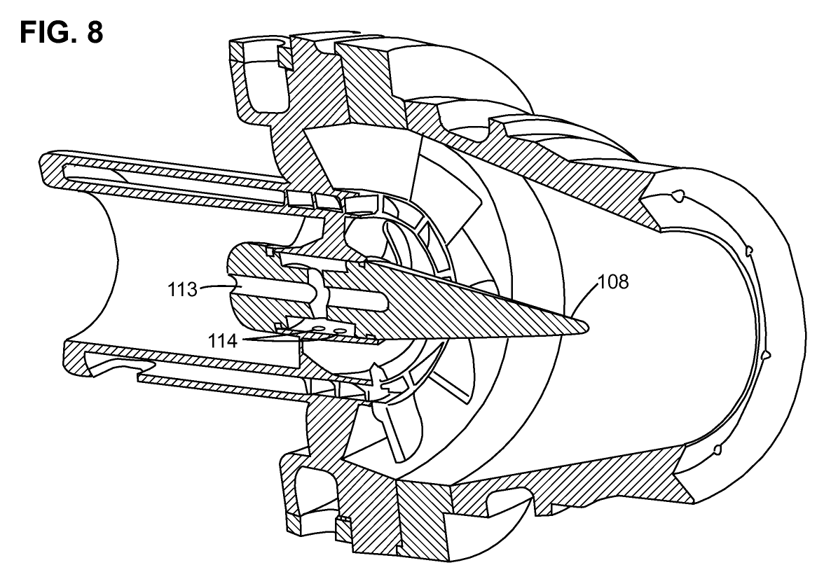

In another embodiment according to the technique of the invention, as illustrated in FIG. 8, the center body 108 may further include an annular passage 113 for high-energy-content fuel in flow communication with a plurality of orifices 114 in flow communication with the inner swirler 80. Those of ordinary skill in the art will appreciate that the provision of additional fuel inlet orifices in the center body would increase the degree of mixing in the fuel-air mixer 72. In another embodiment, not illustrated, the plurality of orifices 114 are positioned preferably immediately downstream of the inner swirler 80 from which fuel can also be injected into the fuel-air mixer 72. It will be understood that if gaseous and liquid fuels are to be injected within the fuel-air mixer 72, the gaseous fuel is preferably to be injected through the swirler vane passages and orifices 112 and the liquid fuel is to be injected through the orifices disposed in the center body 108 downstream of the inner swirler 80. Accordingly, it will be understood that the change of fuel types may be accomplished rather quickly simply by increasing the amount of fuel injected through the orifices disposed in the center body 108 while correspondingly decreasing the amount of fuel injected through the vanes. In another embodiment (not illustrated), the center body 108 may preferably include a passage through a tip thereof in order to admit, air of a relatively high axial velocity into the combustion chamber 76 adjacent the center body 108, this particular embodiment being capable of decreasing the local fuel/air ratio to help push the flame downstream of the center body tip.

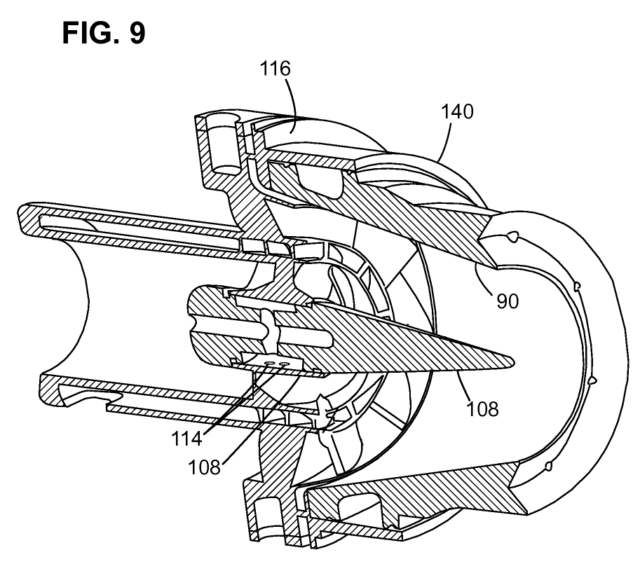

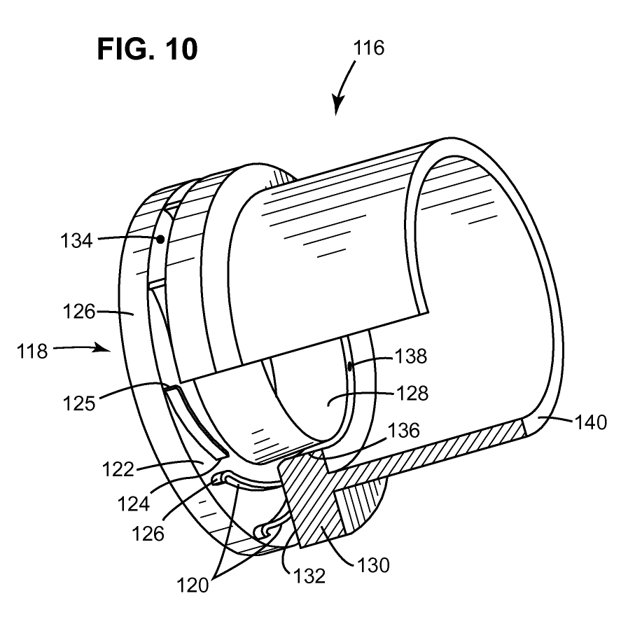

In yet another embodiment according to the technique of the invention, as illustrated in FIG. 9, between the fuel shroud 86 and the annular shroud 90, the fuel-air mixer 72 includes a radial swirler 116. The fuel introduced in either the inner or outer swirlers 80 and 82 may tend to accumulate toward the surface of the annular shroud 90, thus creating a region with a high concentration of fuel at the downstream end 96 of the annular shroud 90. The increased fuel concentration near the exit of the annular shroud 90 may not only increase the likelihood of flash back into the annular shroud 90, but also increase the amount of NOₓ formed in the combustion chamber 76. One of the advantageous features of the radial swirler 116 is that air introduced therethrough enhances fuel air mixing near the surface of the annular shroud 90, thereby reducing and/or eliminating the regions with high fuel concentration at the exit of the annular shroud 90 and thus reducing the overall amount of NOₓ formed in the combustion chamber 76. FIG. 10 shows a perspective view of the radial swirler 116.

As shown in FIG, 10, the radial swirler 116 includes a first ring 118 disposed at an upstream end thereof having a plurality of vanes 120 disposed on an outer surface 122. Each vane 120 is disposed on the outer surface 122 so as to extend circumferentially around the axial axis A of the fuel-air mixer 72 with each first end portion, or trailing edge, 124 of each vane 120 being located radially inward from a second end portion, or leading edge, 125 of each vane 120 positioned next to an outer edge 126 of the first ring 118. As illustrated, the first ring 118 also includes an annular lip 128 extending axially from an inner edge of the first ring 118. Another component of the radial swirler 116 is a second ring 130 disposed axially away from the first ring 118 so as to form a gap therebetween extending both along a radial direction and an axial direction. As shown, a first surface 132 of the second ring 130 extends radially inward, forming a radially extending gap 134 with the outer surface 122 of the first ring 118, where the plurality of vanes 120 is disposed. A second surface 136 of the second ring 130 extends axially so as to form an axially extending gap 138 with the annular lip 128 of the first ring 118. The second ring 130 also includes a sleeve 140, inside of which the annular shroud 90 of the fuel-air mixer 72 is disposed when assembling the fuel-air mixer 72.

The axial location of the radial swirler 116 along the fuel-air mixer 72 relative to the position of the inner and outer swirlers 80 and 82 and/or the degree of radial rotation of the airflow leaving the radial swirler 92 may be determined based on the desired level of mixing of the fuel-air mixture at the downstream end 110 of the fuel-air mixer 72, particularly in the region next to the wall of the annular shroud 92. In addition, the geometry and dimensions of the radial swirler 116 may be selected/optimized based upon a desired premixing efficiency and the operational conditions including factors such as, but not limited to, fuel pressure, fuel temperature, temperature of incoming air, and fuel injection velocity. Examples of fuel include natural gas, high hydrogen gas, hydrogen, biogas, carbon monoxide and syngas. However, a variety of other fuels may also be employed.

Those of ordinary skill in all applicable arts will appreciate that the advantageous features of the fuel-air mixers disclosed herein in FIGS. 4-10 may be used in alternative combinations besides the embodiments illustrated therein. For example, another embodiment of the disclosed fuel-air mixer within the scope of the disclosed invention may include the third swirler combined with the radial swirler without the introduction of fuel through the center body. In addition, it will be appreciated that the disclosed designs and their equivalents are to be used in operation for different types of fuels, as explained. For example, the high-energy-content fuel may be either natural gas and/or pure hydrogen injected through the disclosed high-energy-content-fuel injection ports. In another embodiment, the fuel-air mixer may be operated with a mixture of H₂/N₂ or Syngas (H₃/CO/N₂) supplied via the disclosed low-energy-content-fuel injection ports. These fuel-air mixers may also be used for syngas combustion in partially premixed mode up to 100% premixed, thereby assuring low NOₓ combustion compared to current IGCC combustion systems. Such mixers will incorporate nozzles designed to burn from 100% H₂ to mixtures of CO/H₂/N₂ and steam or another inert, such as CO₂, operating in partially premix or fully premix mode with syngas while not requiring any steam injection for the control of NOₓ.

The above-described embodiments of the fuel-air mixer 72 are particularly suitable for use in integrated gasification combined cycles, or IGCC, which are cycles having a gas turbine driven by the combustion of a fuel that result from the gasification of a solid fuel, such as coal, while the exhaust gases from the gas turbine are heat exchanged with water/steam to generate superheated steam to drive a steam turbine. The gasification portion of the IGCC plant produces a clean coal gas by combining coal with oxygen in a gasifier to produce the gaseous fuel, mainly hydrogen and carbon monoxide, or syngas. A gas cleanup process then cleans the syngas, which is subsequently used in the combustor of the gas turbine to produce electricity. IGCC plants typically have higher efficiencies and lower emissions with higher output. The higher output is accomplished in IGCC plants when nitrogen obtained from an Air Separation Unit, or ASU, is introduced in the combustor of the gas turbine, thereby increasing the mass flow rate through the gas turbine and reducing the overall combustion temperature and oxygen concentration by vitiating the air used for combustion. The fuel-air mixer 72 according to the embodiments of the disclosed invention is suitable for use in IGCC plants. In particular, the fuel-air mixer 72 may be used in the gas turbine combustor and nitrogen may be introduced in the radial swirler 116 when burning syngas, thus helping to decrease the high fuel concentration near the wall and to enhance fuel air mixing properties. This radial swirler can also be utilized such that nitrogen can flow through and mix with hydrogen and air in the shroud during the combustion of pure hydrogen, again avoiding localized high equivalence ratio regions at the exit of the fuel-air mixer.

In typical IGCC gas turbine combustors, hydrogen and nitrogen are introduced together through the fuel injection ports in the inner and outer swirlers 80 and 82. In some of the embodiments disclosed, instead of mixing hydrogen with nitrogen and introducing the mixture through the fuel ports, hydrogen is supplied to the fuel ports and nitrogen is either injected by the radial swirler or supplied with the incoming air, thus vitiating the air in order to reduce the overall availability of oxygen thereby reducing the NOₓ levels by as much as 70% compared to conventional levels. In one of the embodiments of the invention, the NOₓ level at the exit of the combustor is 3-5 ppm or lower. Such an improvement in performance is accomplished while the vitiated air provides an enhanced resistance to flashback and flame holding in the annular shroud 90 of the fuel-air mixer 72. Nevertheless, although the above-summarized advantages are clear for IGCC plants, those of ordinary skill in the art will understand that the disclosed fuel-air mixers may be used to retrofit current combustors of power producing gas turbines.

The fuel-air mixers described above may also be employed in gas-to-liquid system in order to enhance the premixing of oxygen and natural gas prior to reaction in a combustor of the system. Typically, a gas-to-liquid system includes an air separation unit, a gas processing unit, and a combustor. In operation, the air separation unit separates oxygen from air and the gas-processing unit prepares natural gas for conversion in the combustor. The oxygen from the air separation unit and the natural gas from the gas-processing unit are directed to the combustor, where the natural gas and the oxygen are reacted at an elevated temperature and pressure to produce a synthesis gas. In this embodiment, the fuel-air mixer is coupled to the combustor to facilitate the premixing of oxygen and the natural gas prior to reaction in the combustor. Further, the radial swirler 116 of the fuel-air mixer facilitates the entrainment of incoming natural gas to enable the mixing of the natural gas and oxygen at high fuel-to-oxygen equivalence ratios (e.g. about 3.5 up to about 4 and beyond) to maximize syngas production yield while minimizing residence time. In certain embodiment, steam may be added to the oxygen or the fuel to enhance the process efficiency.

The synthesis gas is then quenched and introduced into a Fiseher-Tropsh processing unit, where through catalysis, the hydrogen gas and carbon monoxide are recombined into long-chain liquid hydrocarbons. Finally, the liquid hydrocarbons are converted and fractionated into products in a cracking unit. Advantageously, the fuel-air mixer having the radial swirler generates rapid premixing of the natural gas and oxygen and a substantially short residence time in the gas to liquid system.

The various aspects of the method described hereinabove have utility in different applications such as combustors employed in gas turbines and heating devices, such as furnaces. Furthermore, the technique described here enhances the premixing of fuel and air prior to combustion, thereby substantially reducing emissions and enhancing the efficiency of gas turbine systems. The premixing technique can be employed for different fuels such as, but not limited to, gaseous fossil fuels of high and low volumetric heating values including natural gas, hydrocarbons, carbon monoxide, hydrogen, biogas and syngas. Thus, as already explained, the fuel-air mixer may be employed in fuel flexible combustors for integrated gasification combined cycle (IGCC) for reducing pollutant emissions. In certain embodiments, the fuel-air mixer is employed in aircraft engine hydrogen combustors and other gas turbine combustors for aero-derivatives and heavy-duty machines. Further, the fuel-air mixer may be utilized to facilitate partial mixing of streams, such as oxy-fuel, that will be particularly useful for carbon-dioxide-free cycles and exhaust gas recirculation.

Thus, the premixing technique based upon the additional radial swirler described above enables enhanced premixing and flame stabilization in a combustor. Further, the present technique enables reduction of emissions, particularly NOₓ emissions from such combustors, thereby effecting the operation of the gas turbine in an environmentally friendly manner. In certain embodiments, this technique facilitates minimization of pressure drop across the combustors, more particularly in hydrogen combustors. In addition, the enhanced premixing achieved through the additional radial swirler facilitates enhanced turndown, flashback resistance and increased flameout margin for the combustors.

In the illustrated embodiments, the better mixing of fuel and air allows for better turndown and permitting operation on natural gas and air mixtures having an equivalence ratio as low as about 0.2, Additionally, the flameout margin is significantly improved as compared to existing systems. Further, as described earlier, this system may be used with a variety of fuels, thus providing enhanced fuel flexibility. For example, the range of effective areas as described above allows the system to employ either natural gas or H₂, as a high-energy-content fuel, for instance, and/or syngas as a low-energy-content fuel. The fuel flexibility of such system eliminates the need of hardware changes or complicated architectures with different fuel ports required for different fuels. As described above, the described fuel-air mixers may be employed with a variety of fuels, thus providing fuel flexibility of the system. Moreover, the technique described above may be employed in the existing can or can-annular combustors to reduce emissions and any dynamic oscillations and modulation within the combustors. Further, the illustrated device may be employed as a pilot, in existing combustors.

Methods for premixing a high-energy-content fuel or a low-energy-content fuel and an oxidizer in a combustion system are also within the scope of the embodiments of the invention disclosed, such methods including the steps of drawing a first stream of oxidizer inside an annular shroud of a fuel-air mixer; swirling a first portion of the first stream of oxidizer in an outer swirler in a first direction; swirling a second portion of the first stream of oxidizer in an inner swirler in a second direction, the second direction being opposite to the first direction; and injecting the high-energy-content fuel into the fuel-air mixer from a fuel shroud in flow communication with fuel inlet orifices in the outer swirler or injecting the low-energy-content fuel into the fuel-air mixer from a fuel plenum, the fuel plenum including an annul us formed by inner and outer shrouds extending axially forming a gap therebetween, at least one fuel inlet disposed at an upstream portion of the fuel plenum, and a fuel plenum swirler disposed in the gap formed between the inner and outer shrouds at a downstream portion of the fuel plenum, the inner shroud of the fuel plenum being disposed circumferentially around an outer circumferential end portion of the inner swirler.

With respect to the above description, it should be realized that the optimum dimensional relationships for the parts of the invention, to include variations in size, form function and manner of operation, assembly and use, are deemed readily apparent and obvious to those skilled in the art, and therefore, all relationships equivalent to those illustrated in the drawings and described in the specification are intended to be encompassed only by the scope of appended claims. In addition, while the present invention has been shown in the drawings and folly described above with particularity and detail in connection with what is presently deemed to be practical and several of the exemplary embodiments of the invention, it will be apparent to those of ordinary skill in the art that many modifications thereof may be made without departing from the principles and concepts set forth herein. Hence, the proper scope of the present invention should he determined only by the broadest interpretation of the appended claims so as to encompass all such modifications and equivalents.

What is claimed is:

1. A fuel-air mixer, comprising:
an annular shroud having an axial axis extending along an axial direction, a radial axis extending along a radial direction, and upstream and downstream end portions;
a center body extending along the axial axis of the annular shroud;
an inner swirler having an inner circumferential end portion disposed around an outer surface of the center body, the inner swirler being disposed at the upstream end portion of the annular shroud;
a fuel plenum having an annulus formed by inner and outer shrouds extending axially forming a gap therebetween, a fuel inlet, and a fuel plenum swirler disposed in the gap formed between the inner and outer shrouds at a downstream portion of the fuel plenum, the inner shroud being disposed circumferentially around an outer circumferential end portion of the inner swirler;
an outer swirler having an inner circumferential end portion disposed around the outer shroud of the fuel plenum, the inner and outer swirlers being configured to allow independent rotation of respective first and second portions of a first oxidizer stream entering the annular shroud at the upstream end portion thereof; and
a fuel shroud disposed at the upstream end portion of the annular shroud outwardly from the second swirler in the radial direction and circumferentially around the annular shroud, the fuel shroud being in flow communication with a plurality of fuel injection ports in the outer swirler.

2. The fuel-air mixer according to claim 1, wherein the fuel-air mixer is configured to mix air with a fuel selected from the group consisting of a high-energy-content fuel, a low-energy-content fuel, and a combination thereof.

3. The fuel-air mixer according to claim 2, wherein the fuel plenum is configured to transport the low-energy-content fuel for injection into the fuel-air mixer through the fuel plenum swirler.

4. The fuel-air mixer according to claim 3, wherein the fuel shroud is configured to transport the high-energy-content fuel for injection into the fuel-air mixer through the plurality of fuel injection ports in the outer swirler.

5. The fuel-air mixer according to claim 4, wherein the low-energy-content fuel is a 50/50 mixture of hydrogen and nitrogen or the high-energy-content fuel is natural gas and an effective area of the fuel plenum swirler ranges from about 6.43 to about 8.57 times larger than an effective area of the plurality of fuel injection ports in the outer swirler for injection of the natural gas for a flame temperature ranging from 2000° F. to 3000° F. (or from 1093° C. to 1649° C.).

6. The fuel-air mixer according to claim 4, wherein the low-energy-content fuel is a 60/40 mixture of hydrogen and nitrogen or the high-energy-content fuel is natural gas and an effective area of the fuel plenum swirler ranges from about 4.2 to about 5.6 times larger than an effective area of the plurality of fuel injection ports in the outer swirler for injection of the natural gas for a flame temperature ranging from 2000°°F. to 3000° F. (or from 1093° C. to 1649° C.).

7. The fuel-air mixer according to claim 4, wherein the low-energy-content fuel is syngas or the high-energy-content fuel is natural gas and an effective area of the fuel plenum swirler ranges from about 10.82 to about 14.43 times larger than an effective area of the plurality of fuel injection ports in the outer swirler for injection of the natural gas for a flame temperature ranging from 2000° F. to 3000° F. (or from 1093° C. to 1649° C.).

8. The fuel-air mixer according to claim 4, wherein the high-energy-content fuel is pure hydrogen and an effective area of the plurality of fuel injection ports in the outer swirler for injection of the pure hydrogen ranges from about 1.6 to about 2.14 times larger than the same effective area when the high-energy-content fuel is natural gas.

9. The fuel-air mixer according to claim 1, wherein the center body further comprises an annular passage in flow communication with a plurality of orifices in the inner circumferential end portion of the inner swirler, the annular passage being configured for the injection of a high-energy-content fuel into the fuel-air mixer.

10. The fuel-air mixer according to claim 1, further comprising:
a radial swirler disposed downstream of the inner and outer swirlers, the radial swirler being configured to allow an independent rotation of a second oxidizer stream entering the third swirler from a region outside the wall of the annular shroud, the second gas stream entering the annular shroud at a region adjacent the wall of the annular shroud.

11. The fuel-air mixer according to claim 10, wherein the radial swirler further comprises a first ring having a plurality of vanes disposed on an outer surface thereof and an annular lip extending axially from an inner edge of the first ring, and a second ring disposed axially away from the first ring so as to form a gap therebetween containing the plurality of vanes disposed on the outer surface of the first ring, the second ring including a first surface extending radially inward so as to form a first portion of the gap and a second surface extending axially so as to form a second portion of the gap, the second ring also including a sleeve configured to receive the annular shroud of the fuel-air mixer.

12. A gas turbine combustor comprising the fuel-air mixer of claim 1.

13. A gas turbine, comprising:
a compressor;
a combustor in flow communication with the compressor configured to burn a premixed mixture of fuel and air, the combustor including a fuel-air mixer disposed upstream of the combustor, the fuel-air mixer including,
an annular shroud having a circular cross section, an axial axis extending along an axial direction, a radial axis extending along a radial direction, and upstream and downstream end portions,
a center body extending along the axial axis of the annular shroud,
an inner swirler having an inner circumferential end portion disposed around an outer surface of the center body, the inner swirler being disposed at the upstream end portion of the annular shroud,
a fuel plenum having an annulus formed by inner and outer shrouds extending axially forming a gap therebetween, a fuel inlet disposed at an upstream portion of the fuel plenum, and a fuel plenum swirler disposed in the gap formed between the inner and outer shrouds at a downstream portion of the fuel plenum, the inner shroud of the fuel plenum being disposed circumferentially around an outer circumferential end portion of the inner swirler and the fuel plenum swirler being substantially coplanar with the inner swirler.
an outer swirler having an inner circumferential end portion disposed around the outer shroud of the fuel plenum, the outer swirler being disposed substantially coplanar with the inner swirler and the fuel plenum swirler, the inner and outer swirlers being configured to allow independent rotation of respective first and a second portions of a first oxidizer stream entering the annular shroud at the upstream end portion thereof, and
a fuel shroud disposed at the upstream end portion of the annular shroud outwardly from the second swirler in the radial direction and circumferentially around the annular shroud, the fuel shroud being in flow communication with the outer swirler; and
a turbine located downstream of the combustor and configured to expand a gas stream exiting the combustor.

14. A gas-to-liquid system, comprising:
an air separation unit configured to separate oxygen from air;
a gas processing unit for preparing natural gas;
a combustor for reacting oxygen with the natural gas at an elevated temperature and pressure to produce a synthesis gas enriched with carbon monoxide and hydrogen gas;
a fuel-air mixer disposed upstream of the combustor to facilitate the premixing of oxygen and the natural gas prior to reaction in the combustor, the fuel-air mixer including,
an annular shroud having a circular cross section, an axial axis extending along an axial direction, a radial axis extending along a radial direction, and upstream and downstream end portions,
a center body extending along the axial axis of the annular shroud,
an inner swirler having an inner circumferential end portion disposed around an outer surface of the center body, the inner swirler being disposed at the upstream end portion of the annular shroud,
a fuel plenum having an annulus formed by inner and outer shrouds extending axially forming a gap therebetween, a fuel inlet disposed at an upstream portion of the fuel plenum, and a fuel plenum swirler disposed in the gap formed between the inner and outer shrouds at a downstream portion of the fuel plenum, the inner shroud of the fuel plenum being disposed circumferentially around an outer circumferential end portion of the inner swirler and the fuel plenum swirler being substantially coplanar with the inner swirler,
an outer swirler having an inner circumferential end portion disposed around the outer shroud of the fuel plenum, the outer swirler being disposed substantially coplanar with the inner swirler and the fuel plenum swirler, the inner and outer swirlers being configured to allow independent rotation of respective first and a second portions of a first oxidizer stream entering the annular shroud at the upstream end portion thereof, and
a fuel shroud disposed at the upstream end portion of the annular shroud outwardly from the second swirler in the radial direction and circumferentially around the annular shroud, the fuel shroud being in flow communication with the outer swirler; and; and
a turbo-expander in flow communication with the combustor for extracting work from and for quenching the synthesis gas.

15. The gas to liquid system according to claim 14, further comprising a Fischer-Tropsch processing unit for receiving the quenched synthesis gas and for catalytically converting the quenched synthesis gas into a hydrocarbon fluid and a cracking unit for fractioning the hydrocarbon fluid into at least one useful product.

16. A method for premixing a high-energy-content fuel or a low-energy-content fuel and an oxidizer in a combustion system, comprising:
drawing a first stream of oxidizer inside an annular shroud of a fuel-air mixer through an oxidizer inlet thereof;
swirling a first portion of the first stream of oxidizer in an outer swirler in a first direction;
swirling a second portion of the first stream of oxidizer in an inner swirler in a second direction, the second direction being opposite to the first direction; and
injecting the high-energy-content fuel into the fuel-air mixer from a fuel shroud in flow communication with fuel inlet orifices in the outer swirler, the fuel shroud being generally disposed at a same axial location where the first and second swirlers are located, or
injecting the low-energy-content fuel into the fuel-air mixer from a fuel plenum having an annulus formed by inner and outer shrouds extending axially forming a gap therebetween, a fuel inlet disposed at an upstream portion of the fuel plenum, and a fuel plenum swirler disposed in the gap formed between the inner and outer shrouds at a downstream portion of the fuel plenum, the inner shroud of the fuel plenum being disposed circumferentially around an outer circumferential end portion of the inner swirler.

17. The method of claim 16, further comprising:
drawing a second gaseous stream inside the annular shroud; and
swirling the second gaseous stream in a radial swirler, the radial swirler being disposed downstream of the axial location of the fuel shroud and the inner and outer swirlers, the second gaseous stream being drawn from a region outside the annular shroud, and the swirling of the second gaseous stream being such as to control a fuel concentration near a wall of the annular shroud at an exit of the annular shroud.

18. The method according to claim 16, further comprising:
injecting the high-energy-content fuel into the fuel-air mixer through an annular passage disposed in the center body in flow communication with a plurality of orifices disposed in the inner circumferential end portion of the inner swirler.

19. The method according to claim 16, wherein the oxidizer comprises air or an oxidizer having a volumetric content of about 10% oxygen.

20. The method according to claim 16, wherein the high-energy-content fuel comprises natural gas or hydrogen and the low-energy-con tent fuel is selected from the group consisting of a mixture of 50/50 hydrogen and nitrogen, a mixture of 60/40 hydrogen and nitrogen, and syngas.
